(19) United States
(12) Patent Application Publication
(10) Pub. No.: US 2016/0146371 A1
(43) Pub. Date: May 26, 2016

(54) Water valve key

(71) Applicant: Constantine Dimitri Gerousis, Kifisia (GR)

(72) Inventor: Constantine Dimitri Gerousis, Kifisia (GR)

(21) Appl. No.: 14/544,152

(22) Filed: Nov. 26, 2014

(51) Int. Cl. F16K 31/44

(52) U.S. Cl. CPC F16K 31/44

(57) ABSTRACT

Water valve key Drawing (1) and Drawing (4) for the easy operation of the water valves Drawing (8) from a distance not having to bend or even kneel in order to close the WV Drawing (2) A and Drawing (5) A or open the WV Drawing (2) B and Drawing (5) B.

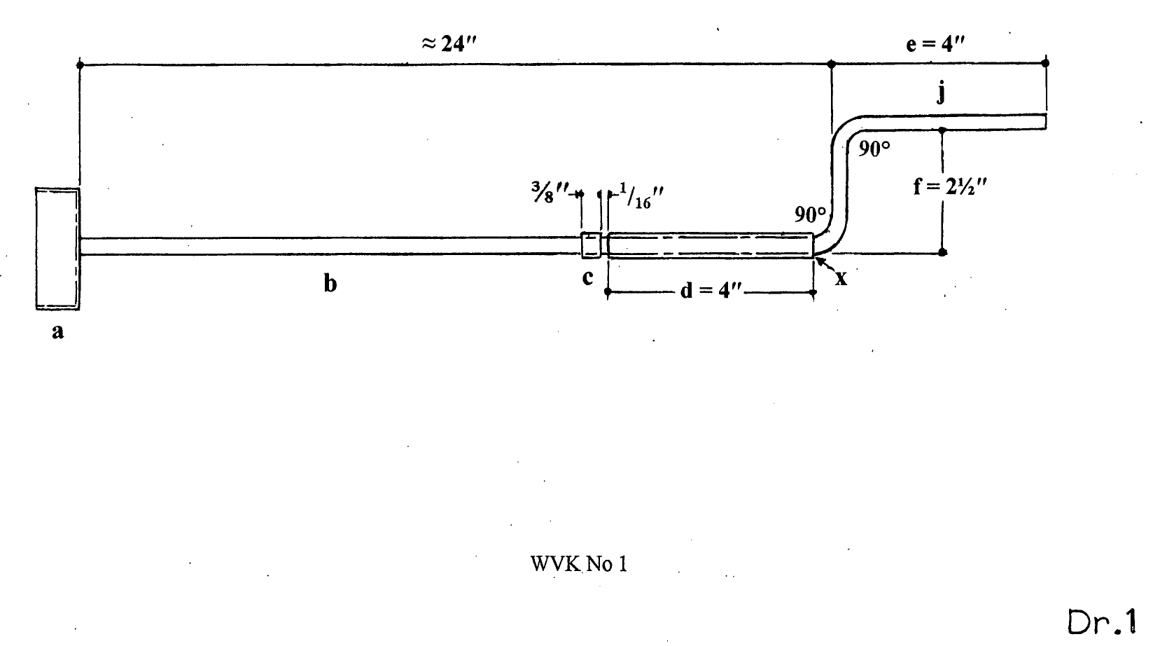

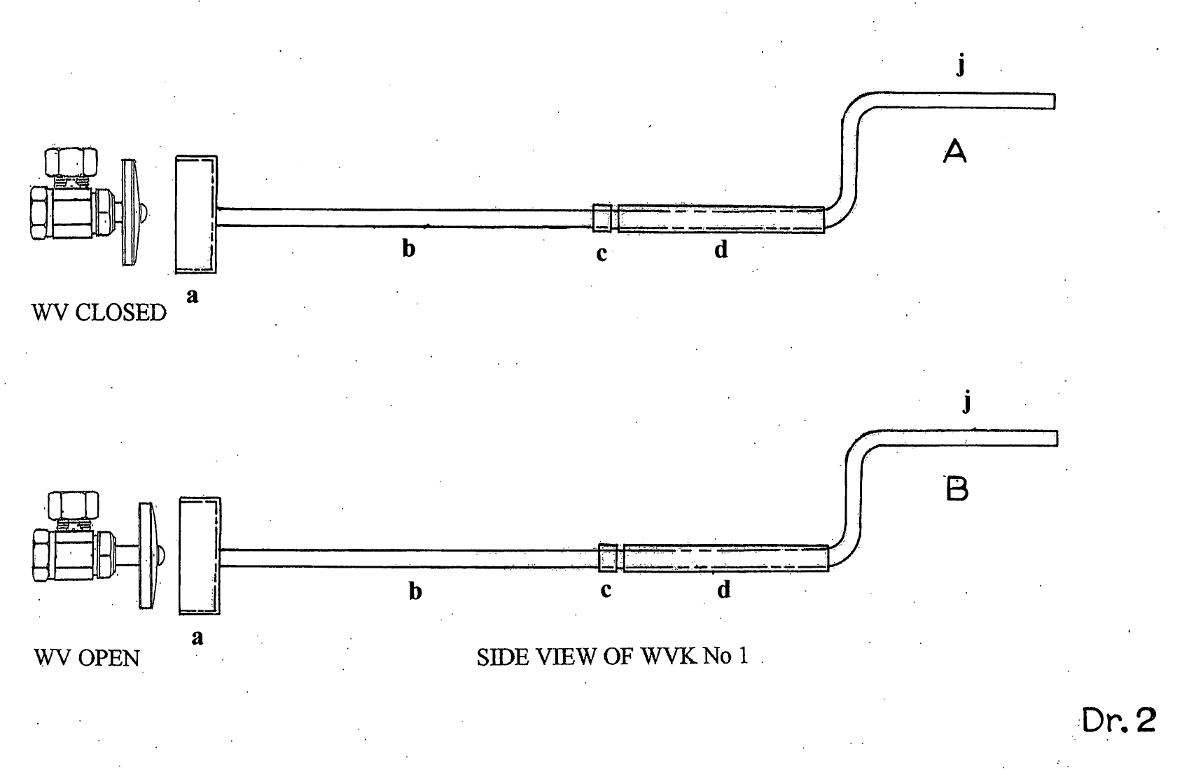

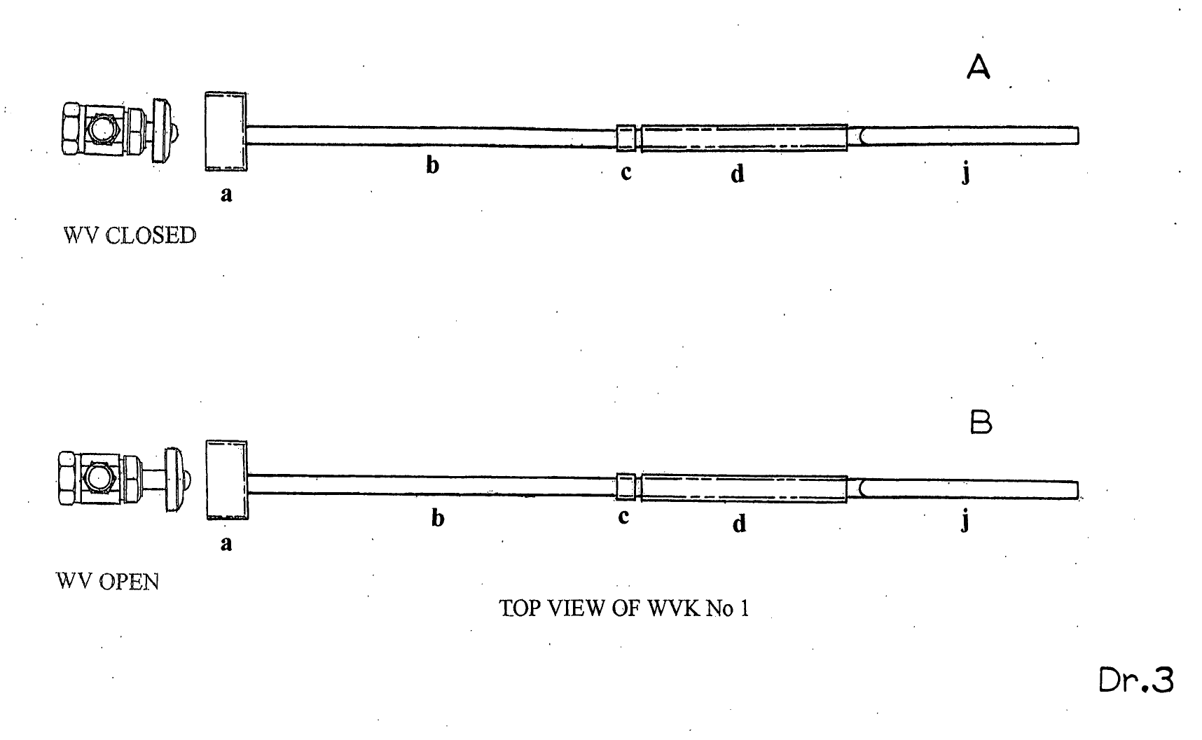

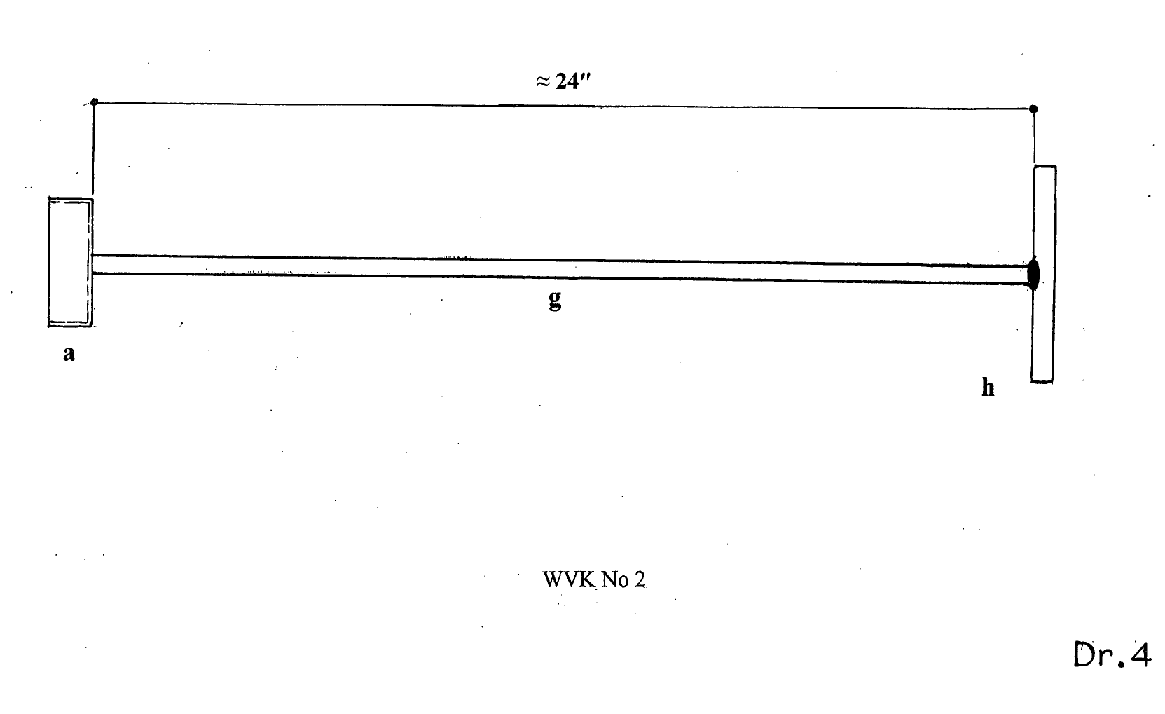

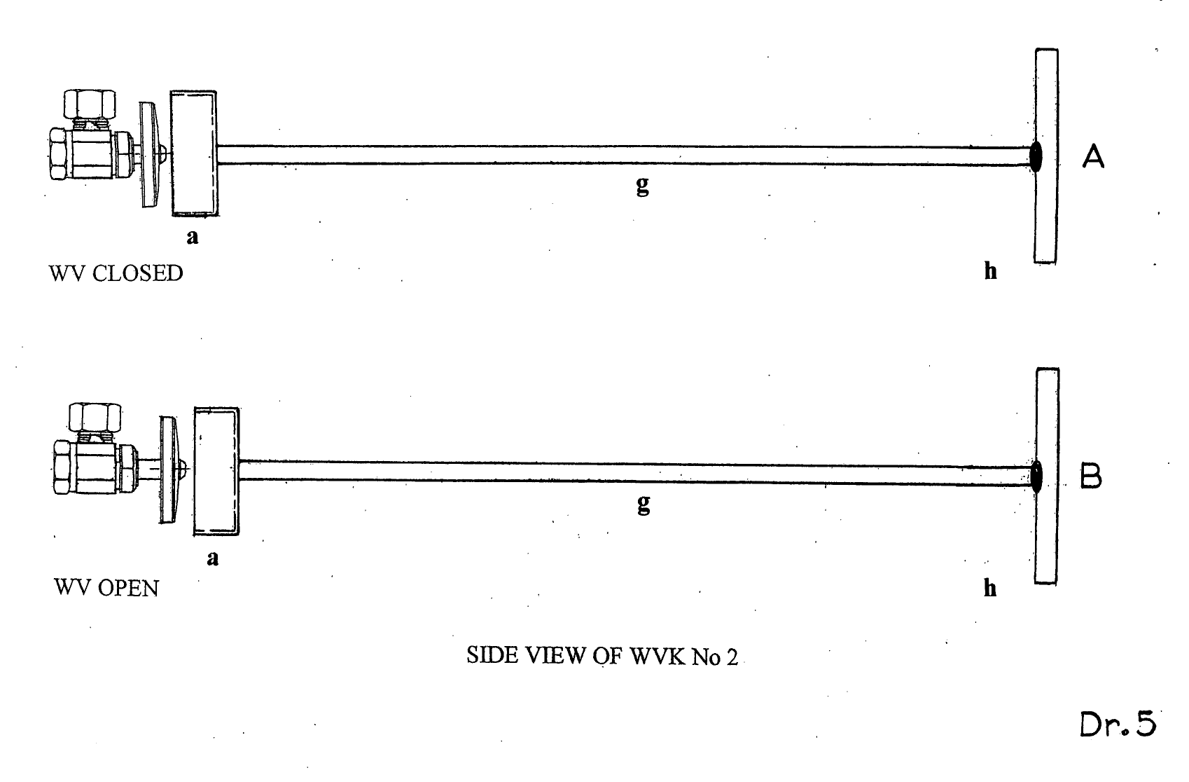

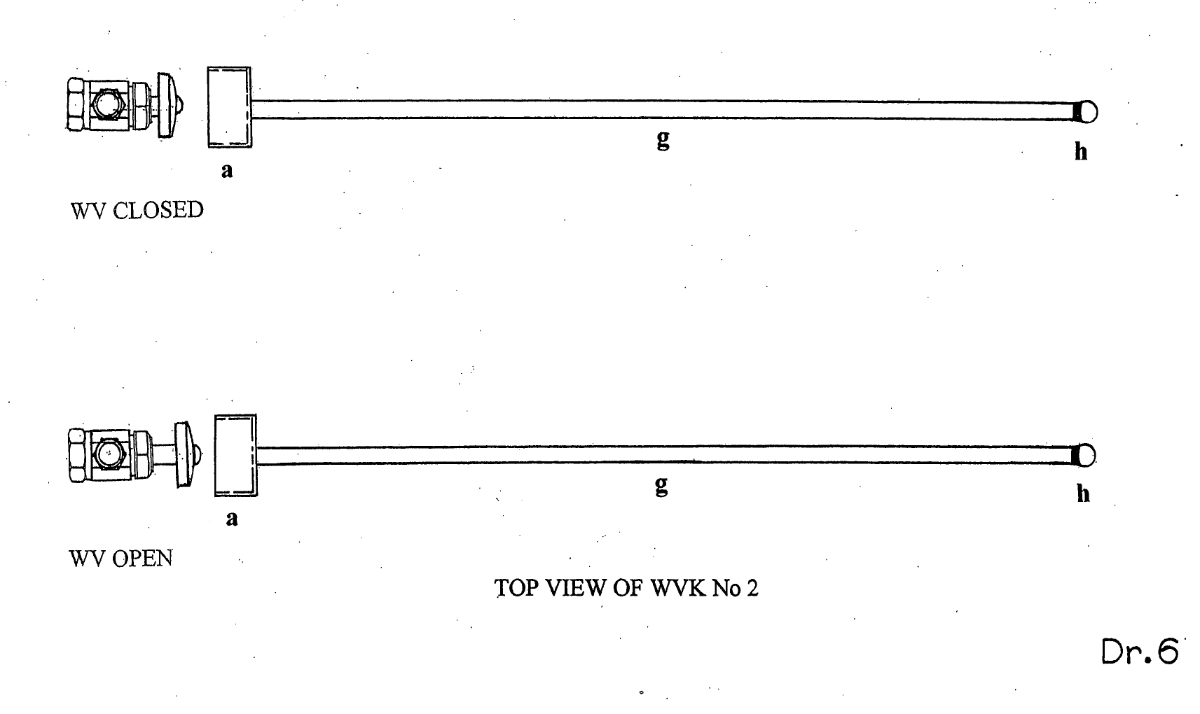

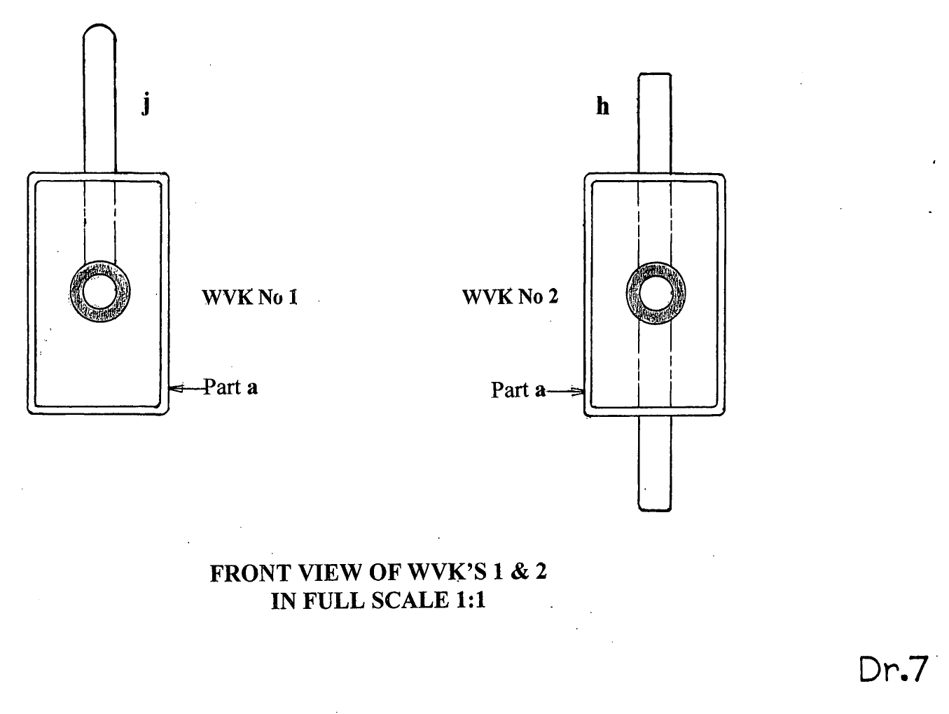

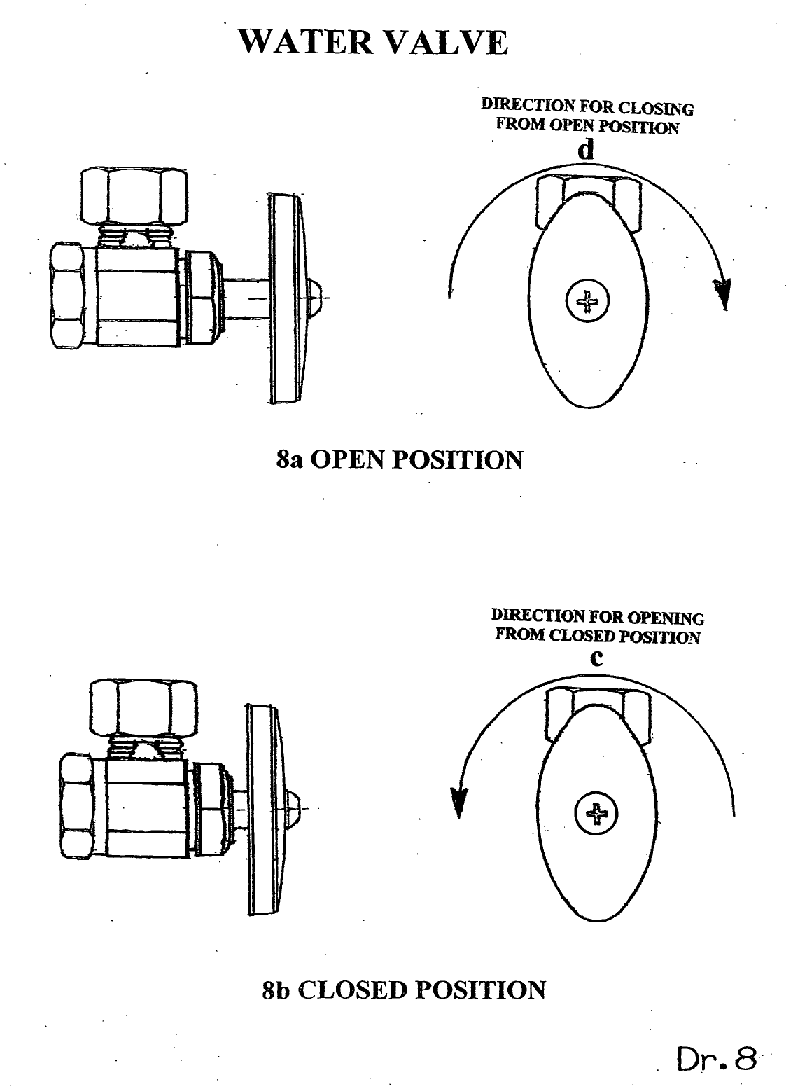

TABLE OF DRAWINGS

| | |
|---|---|
| 1/8 | DR 1 WVK No 1 with angular handle g, Sheet No 3 |
| 2/8 | DR 2 Side View of WVK No 1, A with closed WV, B with open WV |
| 3/8 | DR 3 Top View of WVK No 1, A with closed WV, B with open WV |
| 4/8 | DR 4 WVK No 2 with straight handle h, Sheet No 4 |
| 5/8 | DR 5 Side View of WVK No 2, A with closed WV, B with open WV |
| 6/8 | DR 6 Top View of WVK No 2, A with closed WV, B with open WV |
| 7/8 | DR 7 Front View of WVK No 1 with part a and WVK No 2 with part |
| | a in full scale |
| 8/8 | DR 8 Water Valve 8a in open position, 8b in closed position |

### SPECIFICATIONS

(1) This invention refers to Water Valve Keys (W.V.K.) which will help anyone open and or close the Water Valve (W.V). The WVKs are specifically designed for the WVs under the kitchen and lavatory cabinets. The distance from the front of the cabinets to the W.V is approximately 24″. With the W.V.K we do not have to bend to move things or even kneel in order to reach the W.V.

(2) The W.V.K Drawing (1) is made out of stainless steel, galvanized steel or other suitable material. It consists of a metal rod ¼″ or bigger in diameter and approximately 32½″ long in total Drawing (1)b. At the point Drawing (1)x of the rod Drawing (1)b a handle is formed in L shape with a 90° angle between the side Drawing (1)f 2½″ long and side Drawing (1)e 4″ long leaving approximately a 24″ long straight section of the rod Drawing (1)b. Before the installation of the part Drawing (1)a, a 4″ long stainless steel or other material tube Drawing (1)d with inside diameter 1/32″ wider from the diameter of the rod Drawing (1)b is placed at the point Drawing (1)x followed by a small section Drawing (1)c ⅜″ long of the same material of part Drawing (1)d. The part Drawing (1)c will be glued 1/16″ away from the part Drawing (1)d thus keeping the part Drawing (1)d from sliding of its position. After the installation of the part Drawing (1)c the part Drawing (1)a which has been drilled in order for the rod Drawing (1)b to go through and get welded on the inside surface of the part Drawing (1)a. The shape and the size of part Drawing (1)a depends on the shape, size, and type of the W.V Drawing (8). Holding part Drawing (1)d and rotating the W.V. Drawing (2) B to the direction of Drawing (8)c, W.V. Drawing (8)a will open. Holding part Drawing (1)d, and rotating the W.V. Drawing (2) A to the direction of Drawing (8)d, will close W.V. Drawing (5)b. With this type of W.V. Drawing (8), it takes 3 full 360° rotations to open the W.V. Drawing (8)a, and 3 full 360° rotations to close the W. V. Drawing (8)b.

(3) The W.V.K Drawing (4) is made out of stainless steel, galvanized steel or other suitable material. It consists of a metal rod ¼″ in diameter or bigger and approximately 24″ long Drawing (3)g. On the one end of the rod Drawing (3)g the handle Drawing (4)h ⅜″ in diameter and 4″ long or bigger is welded. On the other end of the rod Drawing (4)g the part Drawing (4)a which has been drilled in order for the rod Drawing (3)g to go through and get welded on the inside surface of the part Drawing (4)a. The shape of the part Drawing (4)a depends on the shape, size, and type of the W.V Drawing (8). Rotating the W.V.K Drawing (5) A to the direction of Drawing (8)c, will open the W.V Drawing (8)a. Rotating W.V Drawing (5) B to the direction of Drawing (8)d will close the W.V Drawing (8)b. With this type of W.V Drawing (8), it takes 3 full 360° rotations to open the W.V. Drawing (8)a, and 3 full 360° rotations to close the W.V Drawing (8)b.

1) Water Valve Key Drawing (1) and Drawing (4) are made out of stainless steel, galvanized steel or other suitable material for the very easy operation of the WV Drawing (8) by opening them Drawing (2) B and Drawing (5) B or closing them Drawing (2) A and Drawing (5) A. Thus we do not have to bend or even kneel in order to reach the W.V Drawing (8) which usually are located under the sinks or the lavatories at a distance of approximately 24″ from the front of the cabinets.
